(19) United States
(12) Patent Application Publication
(10) Pub. No.: US 2020/0320385 A1
(43) Pub. Date: Oct. 8, 2020

(54) USING QUANTIZATION IN TRAINING AN ARTIFICIAL INTELLIGENCE MODEL IN A SEMICONDUCTOR SOLUTION

(71) Applicant: Gyrfalcon Technology Inc., Milpitas, CA (US)

(72) Inventors: Lin Yang, Milpitas, CA (US); Baohua Sun, Fremont, CA (US); Yongxiong Ren, San Jose, CA (US); Wenhan Zhang, Mississauga (CA); Patrick Zeng Dong, San Jose, CA (US)

(73) Assignee: Gyrfalcon Technology Inc., Milpitas, CA (US)

(21) Appl. No.: 16/399,766

(22) Filed: Apr. 30, 2019

Related U.S. Application Data
(60) Provisional application No. 62/830,269, filed on Apr. 5, 2019.

(51) Int. Cl. G06N 3/08; G06N 3/063

(52) U.S. Cl. CPC G06N 3/08; G06N 3/063

(57) ABSTRACT

A system for training an artificial intelligence (AI) model for an AI chip may include a forward network and a backward propagation network. The AI model may be a convolution neural network (CNN). The forward network may infer the output of the AI chip based on the training data. The backward network may use the output of the AI chip and the ground truth data to train the weights of the AI model. In some examples, the system may train the AI model using a gradient descent method. The system may quantize the weights and update the weights during the training. In some examples, the system may perform a uniform quantization over the weights. The system may also determine the distribution of the weights. If the weight distribution is not symmetric, the system may group the weights and quantize the weights based on the grouping.

### PRIORITY CLAIM

This application claims the benefit under 35 U.S.C. 119 of the earlier filing date of U.S. Provisional Application 62/830,269 entitled “TRAINING AN ARTIFICIAL INTELLIGENCE MODEL IN A SEMICONDUCTOR SOLUTION”, filed Apr. 5, 2019. The aforementioned provisional application is hereby incorporated by reference in its entirety, for any purpose.

### FIELD

This patent document relates generally to systems and methods for providing artificial intelligence solutions. Examples of training a convolution neural network model in an artificial intelligence semiconductor solution are provided.

### BACKGROUND

Artificial intelligence (AI) semiconductor solutions include using embedded hardware in an AI integrated circuit (IC) to perform AI tasks. Hardware-based solutions, as well as software solutions, still encounter the challenges of obtaining an optimal AI model, such as a convolutional neural network (CNN) for the hardware. For example, if the weights of a CNN model are trained outside the chip, they are usually stored in floating point. When the weights of a CNN model in floating point are loaded into an AI chip they usually lose data bits from quantization, for example, from 16- or 32-bits to 1- to 8-bits. The loss of data bits in an AI chip compromises the performance of the AI chip due to lost information and data precision. Further, existing training methods are often performed in a high performance computing environment, such as in a central processing unit (CPU) or graphics processing unit (GPU), without accounting for hardware constraints in a physical AI chip. This often causes performance degradation when an AI model trained in a CPU/GPU is loaded into an AI chip.

### BRIEF DESCRIPTION OF THE DRAWINGS

The present solution will be described with reference to the following figures, in which like numerals represent like items throughout the figures.

FIG. 1 illustrates an example training system in accordance with various examples described herein.

FIG. 2 illustrates a flow diagram of an example process of training and executing an AI model in accordance with various examples described herein.

FIGS. 3A-3B illustrate examples of weight distribution for an AI model in accordance with various examples described herein.

FIG. 4 illustrates a flow diagram of an example process of quantizing weights of an AI model in accordance with various examples described herein.

FIG. 5 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

An example of “artificial intelligence logic circuit” and “AI logic circuit” includes a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Examples of “integrated circuit,” “semiconductor chip,” “chip,” and “semiconductor device” include integrated circuits (ICs) that contain electronic circuits on semiconductor materials, such as silicon, for performing certain functions. For example, an integrated circuit be a microprocessor, a memory, a programmable array logic (PAL) device, an application-specific integrated circuit (ASIC), or others. An AI integrated circuit may include an integrated circuit that contains an AI logic circuit.

Examples of “AI chip” include hardware- or software-based device that is capable of performing functions of an AI logic circuit. An AI chip may be a physical IC. For example, a physical AI chip may include an embedded cellular neural network (CeNN), which may contain weights and/or parameters of a CNN. The AI chip may also be a virtual chip, i.e., software-based. For example, a virtual AI chip may include one or more processor simulators to implement functions of a desired AI logic circuit.

Examples of “AI model” include data containing one or more parameters that, when loaded inside an AI chip, are used for executing the AI chip. For example, an AI model for a given CNN may include the weights, biases, and other parameters for one or more convolutional layers of the CNN. Here, the weights and parameters of an AI model are interchangeable.

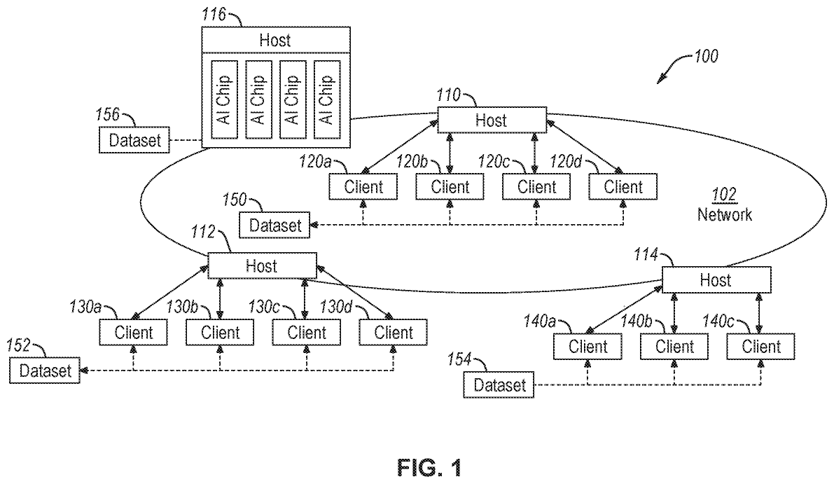

FIG. 1 illustrates an example training system in accordance with various examples described herein. In some examples, a communication system 100 includes a communication network 102. Communication network 102 may include any suitable communication links, such as wired (e.g., serial, parallel, optical, or Ethernet connections) or wireless (e.g., Wi-Fi, Bluetooth, or mesh network connections), or any suitable communication protocols now or later developed. In some scenarios, system 100 may include one or more host devices, e.g., 110, 112, 114, 116. A host device may communicate with another host device or other devices on the network 102. A host device may also communicate with one or more client devices via the communication network 102. For example, host device 110 may communicate with client devices 1120a, 1120b, 120c, 120d, etc. Host device 112 may communicate with client devices 130a, 130b, 130c, 130d, etc. Host device 114 may communicate with client devices 140a, 140b, 140c, etc. A host device, or any client device that communicates with the host device, may have access to one or more training datasets for training an AI model. For example, host device 110 or a client device such as 120a, 120b, 120c, or 120d may have access to the dataset 150.

In FIG. 1, a client device may include a processing device. A client device may also include one or more AI chips. In some examples, a client device may be an AI chip. The AI chip may be a physical AI IC. The AI chip may also be software-based, such as a virtual AI chip that includes one or more process simulators to simulate the operations of a physical AI IC. A processing device may include an AI chip and contain programming instructions that will cause the AI chip to be executed in the processing device. Alternatively, and/or additionally, a processing device may also include a virtual AI chip, and the processing device may contain programming instructions configured to control the virtual AI chip so that the virtual AI chip may perform certain AI functions. In FIG. 1, each client device 120a, 120b, 120c, 120d) may be in electrical communication with other client devices on the same host device, e.g., 110, or client devices on other host devices.

In some examples, the communication system 100 may be a centralized system. System 100 may also be a distributed or decentralized system, such as a peer-to-peer (P2P) system. For example, a host device, e.g., 110, 112, 114, and 116, may be a node in a P2P system. In a non-limiting example, a client devices, e.g., 120a, 120b, 120c, and 120d may include a processor and an AI physical chip. In another non-limiting example, multiple AI chips may be installed in a host device. For example, host device 116 may have multiple AI chips installed on one or more PCI boards in the host device or in a USB cradle that may communicate with the host device. Host device 116 may have access to dataset 156 and may communicate with one or more AI chips via PCI board(s), internal data buses, or other communication protocols such as universal serial bus (USB).

In some scenarios, the AI chip may contain an AI model for performing certain AI tasks. Executing an AI chip or an AI model may include causing the AI chip (hardware- or software-based) to perform an AI task based on the AI model inside the AI chip and generate an output. Examples of an AI task may include image recognition, voice recognition, object recognition, data processing and analyzing, or any recognition, classification, processing tasks that employ artificial intelligence technologies. In some examples, an AI training system may be configured to include a forward propagation neural network, in which information may flow from the input layer to one or more hidden layers of the network to the output layer. An AI training system may also be configured to include a backward propagation network to fine tune the weights of the AI model based on the output of the AI chip. An AI model may include a CNN that is trained to perform voice or image recognition tasks. A CNN may include multiple convolutional layers, each of which may include multiple parameters, such as weights and/or other parameters. In such case, an AI model may include parameters of the CNN model.

In some examples, a CNN model may include weights, such as masks and scalars for one or more convolution layers of the CNN model. In a non-limiting example, in a CNN model, a computation in a given layer in the CNN may be expressed by Y=w*X+b, where X is input data, Y is output data, w is a kernel, and h is a bias; all variables are relative to the given layer. Both the input data and the output data may have a number of channels. Operation “*” is a convolution. Kernel w may include binary values. For example, a kernel may include 9 cells in a 3×3 mask, where each cell may have a binary value, such as “1” and “−1.” In such case, a kernel may be expressed by multiple binary values in the 3×3 mask multiplied by a scalar. In other examples, for some or all kernels, each cell may be a signed 2 or 8 bit integer. Other bit length or values may also be possible.

The scalar may include a value having a bit width, such as 12-bit or 16-bit. Other bit length may also be possible. Alternatively, and/or additionally, a kernel may contain data with non-binary values, such as 7-value. The bias b may contain a value having multiple bits, such as 18 bits. Other bit length or values may also be possible. For example, an output channel of a CNN layer may include one or more bias values that, when added to the output of the output channel, adjust the output values to a desired range. In a non-limiting example, the output Y may be further discretized into a signed 5-bit or 10-bit integer constrained by the activation layer of the CNN. Other bit length or values may also be possible. In some examples, a kernel in a CNN layer may be represented by a mask that has multiple values in lower precision multiplied by a scalar in higher precision. In some examples, a CNN model may include other parameters.

In the case of physical AI chip, the AI chip may include an embedded cellular neural network that has memory containing the multiple parameters in the CNN. In some scenarios, the memory in a physical AI chip may be a one-time-programmable (OTP) memory that allows a user to load a CNN model into the physical AI chip once. Alternatively, a physical AI chip may have a random access memory (RAM), magnetoresistive random access memory (MRAM), or other types of memory that allows a user o update and load a CNN model into the physical AI chip multiple times.

In the case of virtual AI chip, the AI chip may include a data structure that simulates the cellular neural network in a physical AI chip. In other examples, a virtual AI chip may directly execute an AI logic circuit without needing to simulate a physical AI chip. A virtual AI chip may be particularly advantageous when higher precision is needed, or when there is a need to compute layers that cannot be accommodated by a physical AI chip.

In the case of a hybrid AI chip, part of an AI logic circuit may be computed using a physical AI chip, while the remainder can be computed with a virtual chip. In a non-limiting example, the physical AI chip may include all convolutional, MaxPool, and some of the ReLU layers in a CNN model, while the virtual AI chip may include the remainder of the CNN model. In some examples, a host device may compute one or more layers of a CNN before sending the output to a physical AI chip. In some examples, the host device may use the output of a physical AI chip to generate output of an AI task. For example, a host device may receive the output of convolution layers of a CNN from a physical AI chip and perform the operations of fully connected layers.

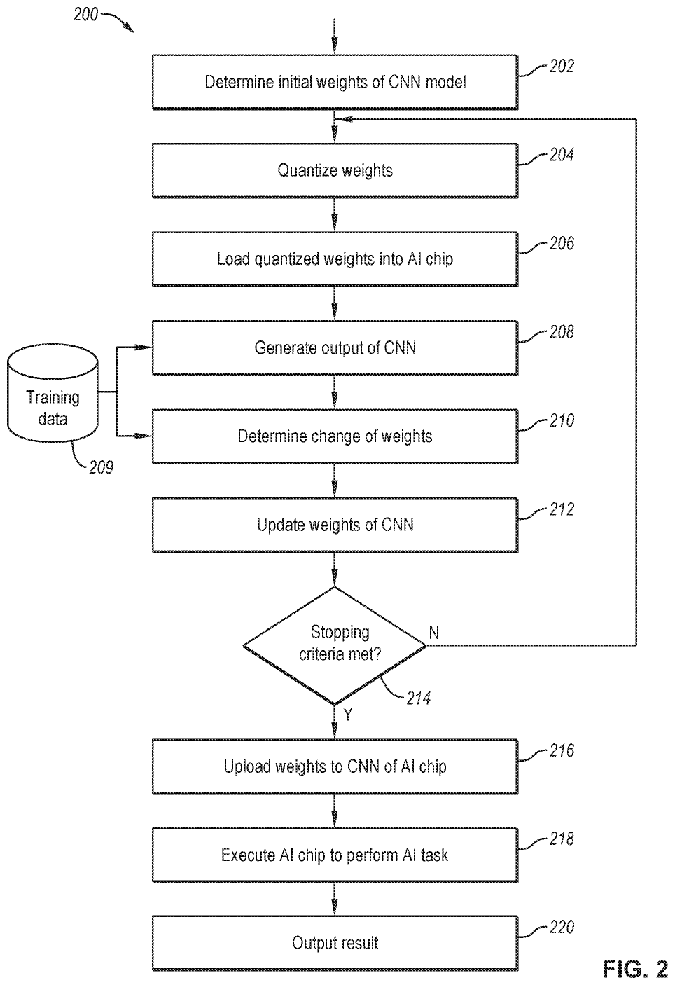

With further reference to FIG. 1, a host device on a communication network as shown in FIG. 1 (e.g., 110) may include a processing device and contain programming instructions that, when executed, will cause the processing device to access a dataset, e.g., 150, for example, test data. The training data may be provided for use in training the AI model. For example, training data may be used for training an AI model that is suitable for an AI task, such as a face recognition tasks, and the training data may contain any suitable dataset collected for performing face recognition tasks. In another example, the training data may be used for training an AI model suitable for scene recognition in video and images, and may contain any suitable scene dataset collected for performing scene recognition tasks. In some scenarios, training data may reside in a memory in a host device. In one or more other scenarios, training data may reside in a central data repository and is available for access by a host device (e.g., 110, 112, 114 in FIG. 1) or a client device (e.g., 120a-d, 130a-d, 140a-d in FIG. 1) via the communication network 102. In some examples, system 100 may include multiple training data sets, such as datasets 150, 152, 154. A CNN model may be trained by using one or more devices and/or one or more AI chips in a communication system such as shown in FIG. 1. Details are further described with reference to FIGS. 2-5.

FIG. 2 illustrates a flow diagram of an example process of training and executing an AI model in accordance with various examples described herein. A training process 200 may perform operations in one or more iterations to train and update the weights of a CNN model, where the trained weights may be output in fixed point, which are suitable for a hardware to execute, such as an AI chip. In some examples, the training process 200 may include determining initial weights of a CNN model at 202, and quantizing the weights of the CNN at 204. In some examples, the process may determine the initial weights in various ways. For example, the process may determine the initial weights randomly. The process may also determine the initial weights according to a pre-trained AI model. In some examples, the initial weights or later updated weights (unquantized weights) may be stored in floating point suitable for training in a desktop environment (e.g., a host device in the system 100 in FIG. 1). For example, the unquantized weights may be stored in 32-bit or 64-bit.

In some examples, quantizing the weights at 204 may include converting the weights from floating points to fixed points for uploading to an AI chip. Quantizing the weights at 204 may include quantizing the weights according to the one or more quantization levels. In some examples, the number of quantization levels may correspond to the hardware constraint of the AI chip so that the quantized weights can be uploaded to the AI chip for execution. For example, the AI chip may include an embedded CeNN. In the embedded CeNN, the weights may include 1-bit (binary value), 2-bit, or other suitable bits, such as 5-bit. In case of 1-bit, the number of quantization levels will be two. In some scenarios, quantizing the weights to 1-bit may include determining a threshold to properly separate the weights into two groups: one below the threshold and one above the threshold, where each group takes one value, such as {1, −1}. In some examples, quantizing the weights into two quantization levels may include a uniform quantization in which a threshold may be determined at the middle of the range of the weight values, such as zero. In such case, the weights having positive values may be quantized to a value of 1 and weights having a negative or zero value may be quantized to a value of −1. In some examples, determining the threshold for quantization may be based on the values of the weights to be quantized or the distribution of the weights.

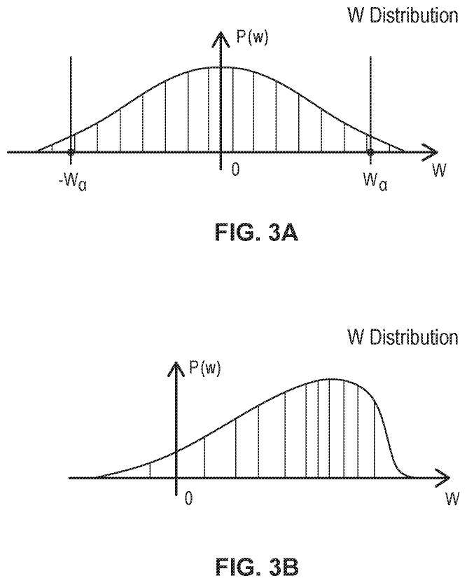

FIGS. 3A-3B illustrate examples of weight distribution for an AI model in accordance with various examples described herein. In FIG. 3A, the distribution of the weights is symmetric about the center axis where W=0. In such case, a threshold at a value of zero may result in a uniform quantization, in which the numbers of quantized weights at each quantization level are approximately equal. Alternatively, and/or additionally, quantizing the weights may also include clipping the weights before quantizing. For example, as shown in FIG. 3A, the weights are clipped at ±W_{α}, where [−W_{α}, W_{α}] represents a range of the weights in the hardware, such as an embedded CeNN in an AI chip. If a weight exceeds the clipping range, it is set to the closest maximum or minimum of the range. For example, a weight having a value above W_{α} may be clipped to W_{α}. Once the weights are cropped, quantizing the weights may map each of the weights to one or more quantization levels as described in the present disclosure.

In FIG. 3B, the weights may have a non-symmetric distribution. When applying uniform quantization, for example, to 1-bit values, the distribution of the resulting quantized weights may not be evenly distributed at the two quantization levels. Alternatively, determining the threshold for quantizing the weights may be based on a non-uniform quantization. An example of non-uniform quantization may include quantizing the weights based on the distribution of the weights.

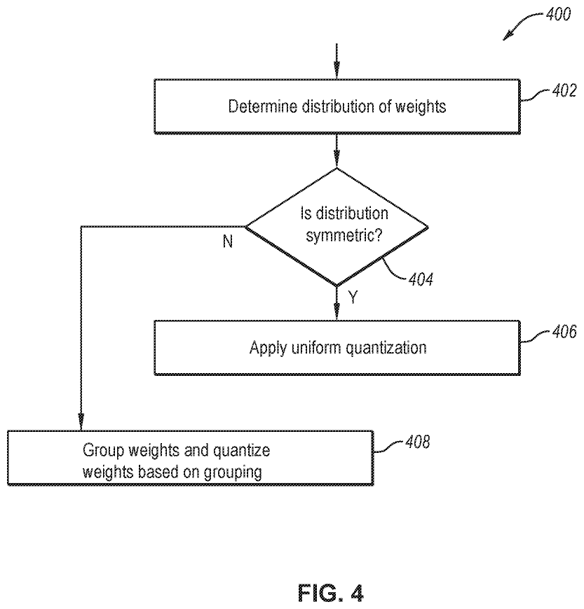

FIG. 4 illustrates a diagram of an example process of quantizing weights of an AI model in accordance with various examples described herein. For example, a process of quantizing weights, 400, may be implemented in 204 (FIG. 2). The process 400 may include determining a distribution of the weights of the CNN model at 402, and determining whether the distribution is symmetric at 404. Upon determining that the distribution of the weights be symmetric, the process may apply a uniform quantization at 406. Upon determining that the distribution of the weights be non-symmetric, the process may group the unquantized weights and quantize the weights based on grouping at 408. For example, the process may quantize each of the weights to a quantization level based on the group to which the weight belongs at 408. The process may use various methods to group weights. In a non-limiting example, the process may apply a clustering method over the unquantized weights, and cluster each of the unquantized weights into one of the clusters, where the number of clusters may be determined based on the distribution of the unquantized weights in an unsupervised manner. For example, the clustering method may include K-means or a kernel K-means method. Once the unquantized weights are clustered, the process may assign each unquantized weight to a quantization level depending on the cluster to which the weight belongs. In another non-limiting example, the process may classify each of the unquantized weights into one of the classes via a training process, such as Bayesian estimation. The process may assign each unquantized weight to a quantization level depending on the class to which the weight belongs.

Returning to FIG. 2, the process 200 may further determine the output of the CNN model at 208 based at least on a training data set and the quantized weights of the CNN model. In some examples, determining the output of the CNN model at 208 may be performed on a CPU or GPU processor outside the AI chip. In some or other scenarios, determining the output of the CNN model may also be performed directly in an AI chip, where the AI chip may be a physical chip or a virtual AI chip. In that case, the process 200 may include loading quantized weights into the AI chip at 206 for execution of the AI model.

The process 200 may further include determining a change of weights at 210 based on the output of the CNN model. In some examples, the output of the CNN model may be the output of the activation layer of the CNN. The process 200 may further update the weights of the CNN model at 212 based on the change of weights. The process may repeat updating the weights of the CNN model in one or more iterations. In some examples, blocks 208-212 may be implemented using a gradient descent method. For example, a loss function may be defined as:

$${H}_{{Y}_{i}} ( Y ) := - {\sum }_{i} {Y}_{i}^{′} log ( {Y}_{i} )$$

where Yᵢ′ is the ground truth of ith training instance, and Yᵢ is the prediction of the network, e.g., the output of the CNN based on the ith training instance. In other words, the loss function H( ) may be defined based on a sum of loss values over a plurality of training instances in the training data set, wherein the loss value of each of the plurality of training instances is a difference between an output of the CNN model for the training instance and a ground truth of the training instance. In some examples, the prediction Yᵢ in the cost function may be calculated by a softmax classifier in the CNN model.

In some examples, the gradient descent may be used to determine a change of weight

ΔW=f(W_{Q}^{t})

by minimizing the loss function H( ), where W_{Q}^{t} stands for the quantized weights at time t. The process may update the weights from a previous iteration based on the change of weight, e.g., W^{t+1}=W^{t}+ΔW, where W^{t} and W^{t+1} stand for the weights in a preceding iteration and the weights in the current iteration, respectively. In some examples, the weights (or updated weights) in each iteration, such as W^{t} and W^{t+1}, may be stored in floating point. The quantized weights W_{Q}^{t} at each iteration t may be stored in fixed point. In some examples, the gradient descent may include known methods, such as a stochastic gradient descent method.

With further reference to FIG. 2, the process 200 may repeat blocks 204 to 212 iteratively, in one or more iterations until a stopping criteria is being met. For example, at each iteration, the process 200 may determine whether a stopping criteria has been met at 214. If the stopping criteria has been met, the process may upload the quantized weights of the CNN model at the current iteration to an AI chip at 216. If the stopping criteria has not been met, the process 200 may repeat blocks 204 to 212 in a new iteration. In determining whether a stopping criteria has been met, the process 200 may count the number of iterations and determine whether the number of iterations has exceeded a maximum iteration number. For example, the maximum iteration may be set to a suitable number, such as 100, 200, or 1000, or 10,000, or an empirical number. In some examples, determining whether a stopping criteria has been met may also determine whether a value of the loss function at the current iteration is greater than a value of the loss function at a preceding iteration. If the value of the loss function increases, the process 200 may determine that the iterations are diverting and determine to stop the iterations.

In some examples, blocks 204-214 may be repeated iteratively in a layer-by-layer fashion for multiple convolution layers in a CNN model. In such case, the weights are updated in each of the multiple convolution layers of the CNN model. Upon the completion of iterations for all of the multiple convolution layers, the process 200 may proceed with uploading the quantized weights of the multiple convolution layers of the CNN model at 216.

Once the trained quantized weights are uploaded to the AI chip, the process 200 may further include executing the AI chip to perform an AI task at 218 in a real-time application, and outputting the result of the AI task at 220. In training the weights of the CNN model, the AI chip may be a physical AI chip, a virtual AI chip or a hybrid AI chip, and the AI chip may be configured to execute the CNN model based on the trained weights. The AI chip may be residing in any suitable computing device, such as a host or a client shown in FIG. 1. In a non-limiting example, the training data 209 may include a plurality of training input images. The ground truth data may include information about one or more objects in the image, or about whether the image contains a class of objects, such as cats, dogs, human faces, or a given person's face. The output of the CNN model may include recognition result indicating a class to which the input image belongs. In the training process, such as 200, the loss function may be determined based on the labels of classes of images in the ground truth and the prediction (e.g., the recognition result) generated from the AI chip based on the training input image. For example, the prediction Yᵢ may be the probability of the image belong to a class, e.g., a cat, a dog, a human face etc., where the probability may be calculated by a softmax classifier in the CNN.

In a non-limiting example, the trained weights of a CNN model may be uploaded to the AI chip. For example, the quantized weights may be uploaded to an embedded CeNN of the AI chip so that the AI chip may be capable of performing an AI task, such as recognizing one or more classes of object from an input image, e.g., a cry and a smiley face. In an example application, an AI chip may be installed in a camera and store the trained weights and/or other parameters of the CNN model, such as those quantized weights generated in the process 200. The AI chip may be configured to receive a captured image from the camera, perform an image recognition task based on the captured image and the stored CNN model, and transmit the recognition result to an output display. For example, the camera may display, via a user interface, the recognition result. In a face recognition application, the CNN model may be trained for face recognition. A captured image may include one or more facial images associated with one or more persons. The recognition result may include the names associated with each input facial image. The AI chip may transmit the recognition result to the camera, which may present the output of the recognition result on a display. For example, the user interface may display a person's name next to or overlaid on each of the input facial image associated with the person.

It is appreciated that the disclosures of various embodiments in FIGS. 1-4 may vary. For example, variations of the processes in FIG. 2 may be possible. In a non-limiting example, another training process may provide initial weights of the process 200. Alternatively, and/or additionally, the trained weights from the process 200 may serve as the initial weights of a third process. Similarly, the training process 200 may be performed multiple times, each using a separate training set. Further, the operations in processes 200 (FIG. 2.) may be performed entirely in a CPU/GPU processor. Alternatively, certain operations in these processes may be performed in an AI chip while other operations are performed in a CPU/GPU processor. It is appreciated that other variations may be possible.

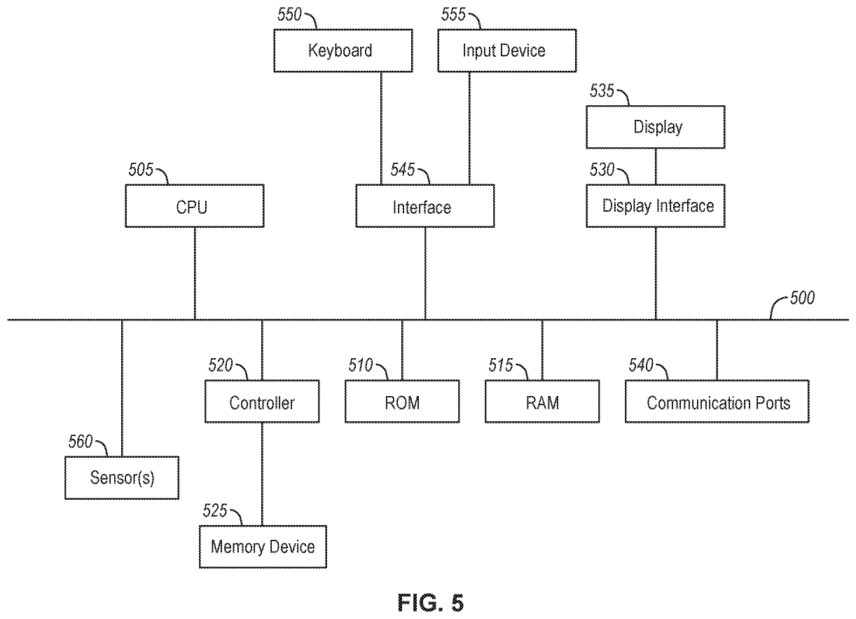

FIG. 5 depicts an example of internal hardware that may be included in any electronic device or computing system for implementing various methods in the embodiments described in FIGS. 1-4. An electrical bus 500 serves as an information highway interconnecting the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU) or a combination of the two. Read only memory (ROM), random access memory (RAM), flash memory, hard drives, and other devices capable of storing electronic data constitute examples of memory devices 525. A memory device, also referred to as a computer-readable medium, may include a single device or a collection of devices across which data and/or instructions are stored.

An optional display interface 530 may permit information from the bus 500 to be displayed on a display device 535 in visual, graphic, or alphanumeric format. An audio interface and audio output (such as a speaker) also may be provided. Communication with external devices may occur using various communication ports 540 such as a transmitter and/or receiver, antenna, an RFID tag and/or short-range, or near-field communication circuitry. A communication port 540 may be attached to a communications network, such as the Internet, a local area network, or a cellular telephone data network.

The hardware may also include a user interface sensor 545 that allows for receipt of data from input devices 550 such as a keyboard, a mouse, a joystick, a touchscreen, a remote control, a pointing device, a video input device, and/or an audio input device, such as a microphone. Digital image frames may also be received from an imaging capturing device 555 such as a video or camera that can either be built-in or external to the system. Other environmental sensors 560, such as a GPS system and/or a temperature sensor, may be installed on system and communicatively accessible by the processor 505, either directly or via the communication ports 540. The communication ports 540 may also communicate with the AI chip to upload or retrieve data to/from the chip. For example, a trained AI model with updated quantized weights obtained from process 200 may be shared by one or more processing devices on the network running other training processes or AI applications. A device on the network may receive the trained AI model from the network and upload the trained weights, to an AI chip for performing an AI task via the communication port 540 and an SDK (software development kit). The communication port 540 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on one or more of those virtual machines on the cloud.

Various embodiments described above may be implemented and adapted to various applications. For example, the AI chip having a CeNN architecture may be residing in an electronic mobile device. The electronic mobile device may use the built-in AI chip to produce recognition results and generate performance values. In some scenarios, training the CNN model can be performed in the mobile device itself, where the mobile device retrieves training data from a dataset and uses the built-in AI chip to perform the training. In other scenarios, the processing device may be a server device in the communication network (e.g., 102 in FIG. 1) or may be on the cloud. These are only examples of applications in which an AI task can be performed in the AI chip.

The various systems and methods disclosed in this patent document provide advantages over the prior art, whether implemented standalone or combined. For example, using the systems and methods described in FIGS. 1-5 may help obtain an optimal AI model that may be executed in a physical AI chip with a performance close to an expected performance in the training process by mimicking the hardware configuration in the training process. Further, the quantization of weights and output values of one or more convolution layers may use various methods. The configuration of the training process described herein may facilitate both forward and backward propagations that would take advantage of classical training algorithms, such as gradient decent, in training weights of an AI model. Above illustrated embodiments are described in the context of training a CNN model for an AI chip (physical or virtual), but can also be applied to various other applications. For example, the current solution is not limited to implementing the CNN but can also be applied to other algorithms or architectures inside an AI chip.

It will be readily understood that the components of the present solution as generally described herein and illustrated in the appended figures could be arranged and designed in a wide variety of different configurations. Thus, the detailed description of various implementations, as represented herein and in the figures, is not intended to limit scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

We claim:

1. A system comprising:
a processor; and
a non-transitory computer readable medium containing programming instructions that, when executed, will cause the processor to:
determine weights of an artificial intelligence (AI) model;
repeat in one or more iterations, until a stopping criteria is met, operations comprising:
quantizing the weights into one or more quantization levels;
determining output of the AI model based at least on a training data set and the quantized weights of the AI model;
determining a change of weights based on the output of the AI model; and
updating the weights of the AI model based on the change of weights;
upon the stopping criteria being met, upload the quantized weights of the AI model to an AI chip for performing an AI task.

2. The system of claim 1, wherein the programming instructions for quantizing the weights comprise programming instructions configured to:
clip the weights of a convolution neural network (CNN) model to a maximum value of a corresponding convolution layer in an embedded cellular neural network of the AI chip; and
quantize the clipped weights of the AI model.

3. The system of claim 1, wherein the programming instructions for quantizing the weights comprise programming instructions configured to cluster the weights of the AI model and assign a weight to a quantization level of the one or more quantization levels based on which cluster to which the weight belongs.

4. The system of claim 1, wherein the programming instructions for quantizing the weights comprise programming instructions configured to:
determine a distribution of the weights of the AI model; and
upon determining the distribution of the weights:
if the distribution of the weights is symmetric, apply an uniform quantization over the weights of the AI model;
otherwise, group the weights of the AI model and quantize the weights to the one or more quantization levels based on the grouping.

5. The system of claim 1, wherein the weights of the AI model are stored in floating point and the quantized weights of the AI model are stored in fixed point.

6. The system of claim 1, wherein the programming instructions for determining the change of weights contain programming instructions configured to use a gradient descent method, wherein a loss function in the gradient descent method is based on a sum of loss values over a plurality of training instances in the training data set, wherein the loss value of each of the plurality of training instances is a difference between an output of the AI model for a training instance and a ground truth of the training instance.

7. The system of claim 6, wherein the stopping criteria is met when a value of the loss function at an iteration is greater than a value of the loss function at a preceding iteration.

8. The system of claim 1, wherein the programming instructions comprise additional programming instructions configured to, by the AI chip:
perform the AI task to generate output based on the quantized weights of the AI model; and
transmit the output of the AI task to an output device;
wherein the quantized weights of the AI model are uploaded into an embedded cellular neural network architecture in the AI chip.

9. A method comprising, at a processing device:
determining initial weights of a convolution neural network (CNN) model;
repeating in one or more iterations, until a stopping criteria is met, operations comprising:
quantizing the weights into one or more quantization levels;
determining output of the CNN model based at least on a training data set and the quantized weights of the CNN model;
determining a change of weights based on the output of the CNN model; and
updating the weights of the CNN model based on the change of weights;
upon the stopping criteria being met, uploading the quantized weights of the CNN model to an artificial intelligence (AI) chip configured to perform an AI task.

10. The method of claim 9, wherein quantizing the weights comprises clustering the weights of the CNN model and quantizing a weight to a quantization level of the one or more quantization levels based on which cluster to which the weight belongs.

11. The method of claim 9, wherein quantizing the weights comprises:
determining a distribution of the weights of the CNN model;
upon determining the distribution of the weights:
if the distribution of the weights is symmetric, applying an uniform quantization over the weights of the CNN model; and
otherwise, grouping the weights of the CNN model and quantizing the weights based on the grouping.

12. The method of claim 9, wherein the weights of the CNN model are stored in floating point and the quantized weights of the CNN model are stored in fixed point.

13. The method of claim 9, wherein determining the change of weights of the CNN model is based on a gradient descent method, wherein a loss function in the gradient descent method is based on a sum of loss values over a plurality of training instances in the training data set, wherein the loss value of each of the plurality of training instances is a difference between an output of the CNN model for a training instance and a ground truth of the training instance.

14. The method of claim 13, wherein determining the change of weights of the CNN model is further based on a stochastic gradient of the quantized weights of the CNN model.

15. The method of claim 13, wherein the stopping criteria is met when a value of the loss function at an iteration is greater than a value of the loss function at a preceding iteration.

16. The method of claim 9 further comprising, by the AI chip:
performing the AI task to generate output based on the quantized weights of the CNN model; and
transmitting the output of the AI task to an output device;
wherein the quantized weights of the CNN model are uploaded into an embedded cellular neural network architecture in the AI chip.

17. A system comprising:
a processor; and
a non-transitory computer readable medium containing programming instructions that, when executed, will cause the processor to:
repeat in one or more iterations, until a stopping criteria is met, operations comprising:
quantizing weights of an artificial intelligence (AI) model into one or more quantization levels;
determining output of the AI model based at least on a training data set and the quantized weights of the AI model;
determining a change of weights based on the output of the AI model; and
updating the weights of the AI model based on the change of weights; and
upon the stopping criteria being met, upload the quantized weights of the AI model to an embedded cellular neural network architecture in an AI chip configured to:
perform an AI task to generate output based on the quantized weights; and
transmit the output of the AI task to an output device.

18. The system of claim 17, wherein the programming instructions for quantizing the weights comprise programming instructions configured to:
determine a distribution of the weights of the AI model; and
upon determining the distribution of the weights:
if the distribution of the weights is symmetric, apply an uniform quantization over the weights of the AI model;
otherwise, group the weights of the AI model and quantize the weights to the one or more quantization levels based on the grouping.

19. The system of claim 17, wherein the weights of the AI model are stored in floating point and the quantized weights of the AI model are stored in fixed point.

20. The system of claim 17, wherein the programming instructions for determining the change of weights of contain programming instructions configured to use a gradient descent method, wherein a loss function in the gradient descent method is based on a sum of loss values over a plurality of training instances in the training data set, wherein the loss value of each of the plurality of training instances is a difference between an output of the AI model for a training instance and a ground truth of the training instance.
